(19) United States
(12) Patent Application Publication
(10) Pub. No.: US 2010/0121511 A1
(43) Pub. Date: May 13, 2010

(54) LI-ION BATTERY ARRAY FOR VEHICLE AND OTHER LARGE CAPACITY APPLICATIONS

(75) Inventors: Per Onnerud, Framingham, MA (US); Scott D. Milne, Boston, MA (US); Richard V. Chamberlain, II, Fairfax Station, VA (US); Shiquan Wang, Northborough, MA (US); Chad Souza, North Providence, RI (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Boston-Power, Inc., Westborough, MA (US)

(21) Appl. No.: 12/574,485

(22) Filed: Oct. 6, 2009

Related U.S. Application Data
(60) Provisional application No. 61/195,441, filed on Oct. 7, 2008.
(60) Provisional application No. 61/176,707, filed on May 8, 2009.

(51) Int. Cl. G06F 7/00; H02J 7/00

(52) U.S. Cl. 701/22; 320/119; 320/134

(57) ABSTRACT

A large battery array, particularly for use in an electric vehicle, is formed of multiple modules, each containing plural battery cells and module management electronics. Each battery module has a nominal output voltage in the range of about 5 volts to about 17 volts. A controller communicates with individual battery modules in the array and controls switching to connect the modules in drive and charging configurations. The module management electronics monitor conditions of each battery module, including the cells it contains, and communicates these conditions to the controller. The module management electronics may place the modules in protective modes based upon the performance of each module in comparison to known or configurable specifications. The modules may be pluggable devices so that each module may be replaced if the module is in a permanent shutdown protective mode or if a non-optimal serviceable fault is detected.

### RELATED APPLICATIONS

This application claims the benefit of U.S. Provisional Application No, 61/195,441, filed Oct. 7, 2008 and U.S. Provisional Application No. 61/176,707, filed May 8, 2009. The entire teachings of the above applications are incorporated herein by reference.

### BACKGROUND OF THE INVENTION

Motor vehicles take several forms including motorcycles, automobiles, buses, trucks, or construction/military vehicles. Currently, the most commonly used motor is an internal combustion engine. An internal combustion engine is an engine in which fuel and an oxidizer, normally air, combust in a confined space (also known as a combustion chamber). The combustion creates gases at high temperatures and pressures. Internal combustion engines are primarily fueled by various types of petroleum derivatives. The combustion also creates exhaust, such as steam, carbon dioxide, particulate matter, and other chemicals.

There are numerous effects caused by reliance on motor vehicles, ranging from dependency on petroleum to negative impacts on the environment. The dependency on petroleum has caused a surge in studies and research to discover new techniques of providing fuel for motor vehicles. Some research and studies have led to new fuel resources, such as hydrogen, corn, solar power, and electric power.

An electric vehicle would use at least one electric motor to operate the drive of a vehicle. The electric vehicle is powered using electricity that can come from devices such as batteries, fuel cells, or generators. Battery powered electric vehicles may require several thousands of battery cells in order to operate, which may account for a significant portion of the overall weight of the electric vehicle. Current hybrid electric vehicles incorporate traditional propulsion systems with a rechargeable battery energy storage system which results in improved fuel economy in comparison to conventional motor vehicles as well as a reduction in car emissions, with a reduction in the required size of the battery relative to fully electric vehicles. A plug-in hybrid electric vehicle (PHEV) uses batteries that are charged via a connection to an alternating current (AC) source of electric power but the vehicle still contains an internal combustion engine to serve as an additional power reserve and battery charger.

Many vehicular and non-vehicular applications exist today which require the use of large capacity batteries including the following: traction batteries for electric vehicles such as HEV/PHEV/EV trucks, cars, and bikes; batteries for unmanned autonomous land, sea and air vehicles; auxiliary power units (APUs) for trucks, recreational vehicles, marine, military, and aerospace applications; load balancing systems for electric grids including balancing systems for adjusting to inherent variation in renewable energy sources such as solar and wind power generation; uninterruptable power supplies; starter batteries for planes; and back-up batteries at power plants.

### SUMMARY OF THE INVENTION

The summary that follows details some of the embodiments included in this disclosure. The information is proffered to provide a fundamental level of comprehension of aspects of the present invention. The details are general in nature and are not proposed to offer paramount aspects of the embodiments. The only intention of the information detailed below is to give simplified examples of the disclosure and to introduce the more detailed description. One skilled in the art would understand that there are other embodiments, modifications, variations, and the like included within the scope of the claims and description.

An example embodiment provides a cost-effective and safe means of manufacturing a large battery array by leveraging the existing technology that has been developed in the notebook personal computer (PC) market and the volume in which those technologies are currently manufactured. The battery array comprises an array of battery modules containing numerous storage cells, each of which may, for example, correspond to a lithium-ion battery pack used in a PC. Further, by modularizing the storage cells, serviceability and maintenance procedures can be greatly simplified, with a controller that is able to identify which individual module is in need of replacement or repair.

When assembling storage cells into each module of the battery array, storage cells with similar impedance and capacity are selected. Because the storage cell with the lowest capacity or highest impedance in a battery module determines the total performance of the module, cells in a given module are selected to have similar impedance and capacity characteristics so to extract the largest amount of energy from that module. Similarly, when assembling modules into a battery array, it is preferable to select modules with similar impedance and capacity thereby minimizing the amount of “waste” energy that the user can not extract from the battery array. Maintenance procedures for the replacement of weak or damaged modules insure that the new module has correct capacity and impedance characteristics corresponding to the serviced battery array. Selecting cells in this way increases cycle life of the module compared to non capacity and impedance balanced modules.

The modularized array supports three primary modes of operation: low voltage charging, discharging, and isolation. In the low voltage charging mode, a supply voltage, particularly an alternating current supply voltage, is down-converted to individual direct current (DC) charging voltages. The DC charging voltages are applied to respective individual battery modules to charge plural battery cells in each battery module. The multiple cells in each battery module may be charged under control of module management electronics in each module. All modules in the array may be charged simultaneously in parallel through parallel converters. While charging, modules may be selectively connected and disconnected from their low voltage charging sources to minimize overall charging time and maximize useable lifetime of the entire battery array. The discharging mode configures modules in series to enable connection to an external load. Energy is then transferred from the modules to the load. In the isolation mode, each module is isolated from the other modules in order to minimize self discharge of the array. Isolation mode is also used when sensors in the battery array detect a possible unsafe operating condition. The modules disconnect from each other to minimize safety risk associated with inadvertent connection to an external load.

In one embodiment, the present invention provides an electric vehicle comprising the following: an electric drive, an array of battery modules to power the electric drive, a controller, and charging circuitry. Each battery module of the array includes a plurality of electrical energy storage cells and module management electronics to monitor each battery module, control each battery module in protective modes, and communicate conditions of each battery module. The controller may be used to receive module conditions communicated from the module management electronics and may control operation of the individual battery modules. The controller may control charging of the individual battery modules to allow for balancing the battery modules during charging. The controller may switch out battery modules based on the condition of each battery module. The controller may attempt to restore a weak or improperly functioning module by initiating a conditioning routine in that module. The controller may monitor the State of Health (SOH) and other parameters associated with the modules and maintain a historical record of these parameters for later use. The controller may provide a service request signal to the user to indicate that a particular module is in need of maintenance. During a maintenance procedure, the controller may supply a service provider with information such as the identification and location of the module in need of repair, as well as desired parametric information about replacement modules such as capacity and impedance so as to match the replacement module to the other existing modules in the battery array.

The switching elements used to connect a module into the series string and to connect the charging circuitry to each module are preferably of the solid state variety implemented as Field Effect Transistors (FETs) as opposed to mechanical relays. FET switches have higher reliability because there is no mechanical wear. Additionally, an FET's turn-on and turn-off times are faster than mechanical equivalents. FET switches are frequently more compact devices and are well suited for low profile assembly on a printed circuit board.

The charging circuitry may be used to charge the battery modules from a current source, preferably an alternating current source in a fully electric or plug-in hybrid system. Multiple individual chargers may each be coupled to one or more battery modules. The multiple individual chargers may operate together in parallel to charge only those modules which are in need of charging. The battery array controller may selectively connect and disconnect the individual chargers to and from their respective modules. The controller may use an algorithm to select optimum charging time sequences for each module, taking into account the module's present and historical parameters and their evolution in time. The controller algorithm may seek to equalize or balance the State of Charge (SOC), open circuit voltage, impedance and other parameters among the modules to within a certain tolerance range for each parameter. The primary objective of such a control algorithm may be to minimize the time necessary to charge the entire battery array and also to maximize the usable lifetime of the battery array.

Each module may have an associated set of parameters that are available to the central battery array controller. For example, when using the Texas Instruments bq20z90 gas gauge or similar device in the module, the following module parameters would be available to the battery array controller: temperature, voltage of module, instantaneous current, average current, SOC, full charge capacity, charge cycle count, design charge capacity, date of module manufacture, SOH, safety status, permanent failure alert, permanent failure status, design energy capacity, lifetime maximum and minimum module temperatures, lifetime maximum and minimum cell voltages, lifetime maximum and minimum module voltages, lifetime maximum charging and discharging current level, lifetime maximum charging and discharging power, voltage of each cell, and charge of each cell.

Each battery module may have a nominal output voltage in the range of about 5V to 17V, corresponding to the voltages found in PC battery packs. Preferred three-cell modules would have a nominal voltage of at least 9V, preferable about 11V, and preferred four-cell modules would have a nominal voltage of at least 12V, preferably about 15V. Another preferred arrangement is 3 series, 2 parallel cell and 4 series, 2 parallel cell modules, each with the same respective nominal voltage range as the three-cell and four-cell modules.

Each battery module may provide for individual removal and replacement under guidance of the central battery array controller. The module management electronics may be used to monitor temperature, current, capacity, and voltage for each storage cell and for the individual battery modules as described above. The module management electronics may be used to control the battery module in either temporary shutdown protective mode or permanent shutdown protective mode. The module management electronics may also communicate overcharge, overdischarge, and temperature of each battery module. The module management electronics may control the balancing of the storage cells of each battery module as well as the tracking of impedance in each cell. The module management electronics, under guidance of the central battery array controller may seek to balance certain parameters such as the SOC, impedance, and open circuit voltage between cells in the same module; and also balance certain similar parameters, such as the SOC, impedance, and open circuit voltage, between modules in the entire battery array.

Another example embodiment of the electric vehicle may include an external power storage device that may be coupled to a generator to store energy converted during braking and to charge the array of batteries by discharging the stored energy.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates example electronic circuitry that may be present in an embodiment to power the drive of a motor vehicle.

FIG. 2 illustrates the electronic circuitry of FIG. 1 configured to charge the battery modules using a current source.

FIG. 3 is a schematic illustration of the electronic circuitry that may be present in a battery module.

FIG. 4 is a schematic illustration of electronic circuitry that may be used when employing modified battery modules.

FIG. 5 is an illustration of an embodiment that uses a regenerative braking system to charge the battery modules.

### DETAILED DESCRIPTION OF THE INVENTION

A description of example embodiments of the invention follows.

Current notebook PC battery packs already contain electronics that control the charging, discharging, balancing, and monitoring of lithium-ion battery cells. The present disclosure incorporates the primary features of the existing technology in notebook PC battery packs to provide “battery modules” in the vehicle battery. Each module may contain several lithium-ion cells and electronics to control the charging, discharging, monitoring, balancing, and protective modes of those cells. The array may also include the necessary AC adapters to provide the required. DC voltage to charge itself (the size of which would be optimized for the desired charging time of the battery modules). The battery modules of the array may be controlled by the module management electronics and charged using low-voltage by a power adapter, all of which are connected to a high-voltage power bus. A network of switches allows those battery modules to be connected in series when discharging and to be isolated from one another when charging. Multiple sets of series-connected battery modules may be connected in parallel within the array for higher power output.

The individual battery modules may contain circuitry similar to that included in existing notebook PC battery management circuitry that has the ability to communicate the temperature, current, capacity, voltage, state-of-health, state-of-charge, cycle count, and other parameters back to a controller that would monitor each battery module and control the charging and discharging of each battery module. In order to allow continuous communication (i.e., both during the charging and discharging states) between the controller and the module management electronics of each battery module, the communication bus of each battery module may be galvanically isolated from the controller as through inductive, capacitive or optical coupling.

The controller may also provide a real-time load power limit feedback signal to a vehicle drive controller in order prevent over-discharge and/or over-temperature conditions within the array. The load power limit feedback signal allows the vehicle drive controller to reduce the maximum vehicle drive load based on up-to-date temperature and SOC conditions of the array. The controller may also notify the user (or operator) of the vehicle when a battery module (or a storage cell included therein) needs maintenance through a communications bus that is common to other systems within the vehicle. An example of a common vehicle communication bus widely used in the automotive industry would be the Control Area Network (CAN) bus which is typically used by a number of vehicle systems, including, but not limited to, climate controls, security systems, and tire pressure sensors. The controller's connection to the common vehicle communication bus may be galvanically isolated as through inductive, capacitive or optical coupling in order to limit potential Electromagnetic and Radio-Frequency Interference (EMI/RFI) paths.

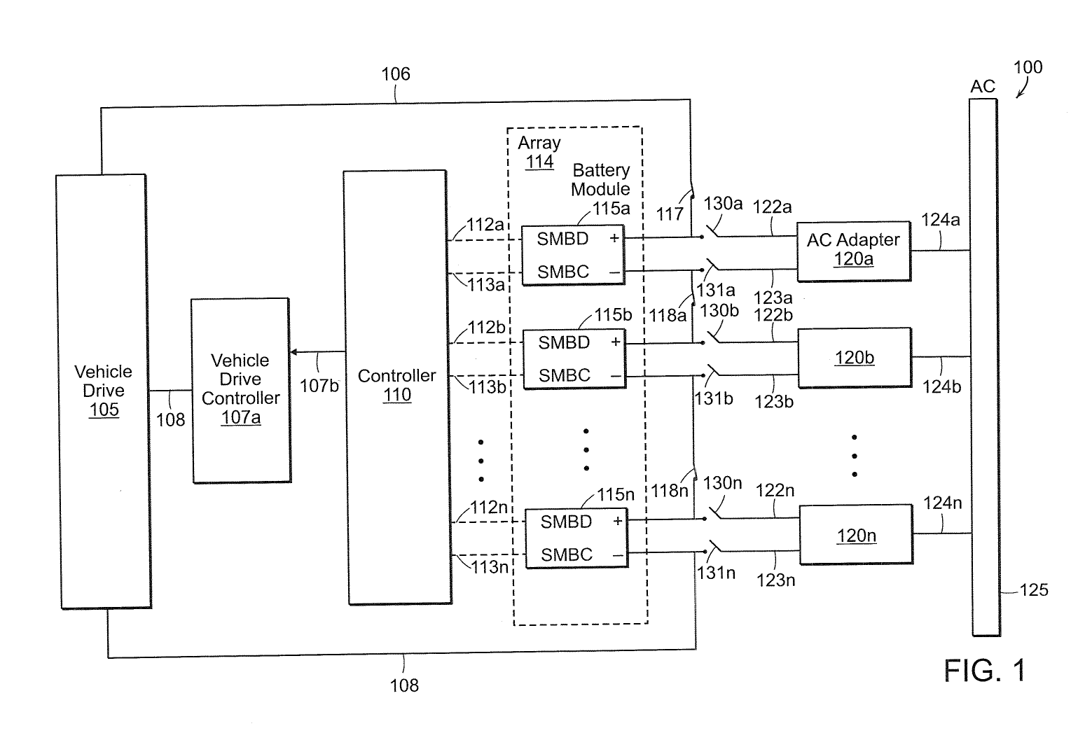

FIG. 1 illustrates example electronic circuitry 100 that may be present in one embodiment to power the drive of a motor vehicle. The electronic circuitry 100 includes a vehicle drive 105, seen as a load to an array 114 of battery modules 115a-n (collectively referred to as 115), a controller 110, a vehicle drive controller 107a, and alternating current (AC) adapters 120a-n, which allow for low voltage charging of the modules from an AC charging bus 125 of, for example, 110 V or 220V. The battery modules 115a-n are connected in series to provide a high voltage required by the vehicle drive from the modules 115 having a nominal output voltage in the range of about 5V to about 17V, as used in PCs. Additional serial arrays may be coupled in parallel to increase the available power to the drive.

Each battery module 115a-n may include several electric energy storage cells (not shown in FIG. 1) and module management electronics (not shown in FIG. 1). The storage cells of each battery module 115a-n may have a nominal voltage output in the range of 2.5V to 4.2V, likely at least 3V. One embodiment has storage cells with a voltage output of 3.7V. If those storage cells are used in a three storage cell battery module 115, the battery module 115 would have a nominal output voltage of at least 9V, preferably about 11.1V. If those storage cells are used in a four storage cell battery module 115, the battery module 115 may have a nominal output voltage of 14.8V. As in a PC battery pack, the module management electronics may monitor each battery module 115, control each battery module 115 in protective modes, communicate conditions of each battery module 115, and control balancing of the storage cells during charging. The module management electronics may be programmed to perform these functions. The module management electronics may activate a cell balancing function as needed to equalize voltages, SOC, or another parameter, among the cells in that module. During charging, the module management electronics monitor the storage cells to prevent overcharging.

The number of battery modules 115 is dependent on the type of system in which the modules 115 are employed. For example, a scooter may only require one battery module 115a, but a car may require ten battery modules 115. The typical voltage requirement for a hybrid electric vehicle is 300V. Thus, twenty seven 11.1V modules or twenty 14.8V modules might be connected in series. If additional power is required, more sets of series connected battery modules 115 may be used. It may be necessary to connect the sets connected in parallel, but arranging a single set of battery modules 115 in series may be sufficient for a hybrid system.

A controller 110 may be configured to receive module conditions from module management electronics of each battery module 115a-n. The controller 110 may also be configured to control the operation of each individual battery module 115a-n in the array 114, such as switching modules into and out of the array and additional control of the balancing of the battery modules during charging. When the vehicle drive 105 is in operation, the battery modules 115 are likely not coupled 122a-n, 123a-n to AC adapters 120a-n or the AC charging bus 125 via connections 124a-n.

The controller 110 may be in communication through lines (represented as dashed lines) 112a-n, 113a-n with the module management electronics of each battery module 115. The communication is represented in FIG. 1 as SMBD (data) and SMBC (clock) terminals of the module management electronics of each battery module, and will be explained in further detail below. By collecting condition data over time from each battery module 115, the controller 110 may maintain up-to-date condition information for each battery module 115a-n, e.g., temperature, current, capacity, and voltage. The maintenance of up-to-date condition information allows the controller 110 to monitor and detect faults in the each battery module 115a-n, such as battery module imbalance, thermal fuse activation, non-optimal temperature, etc. The maintenance of up-to-date condition information also allows the controller 110 to determine available battery power in real-time. The controller 110 may also be programmed with an algorithm to determine available battery power based on up-to-date weakest module SOC information, temperature, and battery pack power specifications. The controller 110 uses available battery power determination to provide a real-time load power limit feedback signal 107b to the vehicle drive controller 107a, which is in communication 108 with the vehicle drive 105. The load power limit feedback signal may be a linear proportional pulse width modulated (PWM) signal with 100% duty cycle representing full load power available and 0% duty cycle representing no load power available.

If the module management electronics detect that the temperature of a battery module 115 is too high, the module management electronics may place the battery module 115 in a permanent shutdown protective mode. However, if the module management electronics detect that the temperature of the battery module 115 is too cold, the module management electronics may place the battery module 115 in a temporary shutdown protective mode. If the module management electronics detect a non-optimal temperature of the battery module 115, the controller 110 may place the battery module 115 in a temporary shutdown protective mode. If a battery module 115 is placed in permanent shutdown protective mode, the battery module 115 will no longer be allowed to operate. That information will be communicated by the module management electronics to the controller 110 and the controller 110 will communicate to the operator of the electric vehicle system that the battery module must be replaced. However, if the module management electronics place a battery module 115 in temporary shutdown protective mode, the controller 110 may notify the operator of the vehicle that a battery module 115 has experienced a fault but the battery module 115 will not require immediate replacement. Whenever a module is shutdown, a backup module may be switched into the series circuit. If none is available, and if sets of battery modules 115a-n are connected in parallel, the controller 110 may also require that a parallel battery module be shut down to maintain equal voltage output from the parallel sets.

A controller 110 may also be programmed with an algorithm to monitor the SOC, SOH, and/or cycle count of the array 114 of battery modules and/or with an algorithm to control the switches between the battery modules 115a-n and the AC adapters 120a-n (e.g., switches 118a-n, 130a-n, 131a-n). A controller 110 may also be used to perform the following functions: (i) coordinate and process the data communicated from each battery module 115, (ii) deliver data detailing the condition of the array 114 of battery modules to a vehicle drive controller 107a of a motor vehicle, and (iii) monitor and track the SOH, SOC, cycle count, and/or other parameters of each battery module 115 which allows for the detection of service functions of each battery module 115 (e.g., detecting the weak battery modules which will result in the need for replacement in a service station). As such, the controller 110 may place a battery module 115 in a protective mode based upon the performance of the battery module 115, for example, if a battery module 115 is performing less efficiently than other battery modules 115.

Each battery module 115 may be configured for individual removal and replacement by including additional switches or relays. Once the operator receives a warning that a battery module 115 has experienced a fault, the operator may take the vehicle to a service station and a technician (or service provider) will be able to retrieve the identity of the faulty battery module and replace the faulty battery module. Based upon the data collected regarding the battery modules 115, e.g., SOH, cycle count, capacity, etc., the technician may approximate the appropriate specifications (e.g., age, capacity, voltage, and the like) of a replacement battery module. Since the battery modules 115 are pluggable, the technician would need only detach the faulty battery module and plug-in the replacement battery module. The controller 110 may also be programmed to recommend the appropriate specifications for the replacement battery module and communicate the recommendation to a service provider through a common vehicle communications bus.

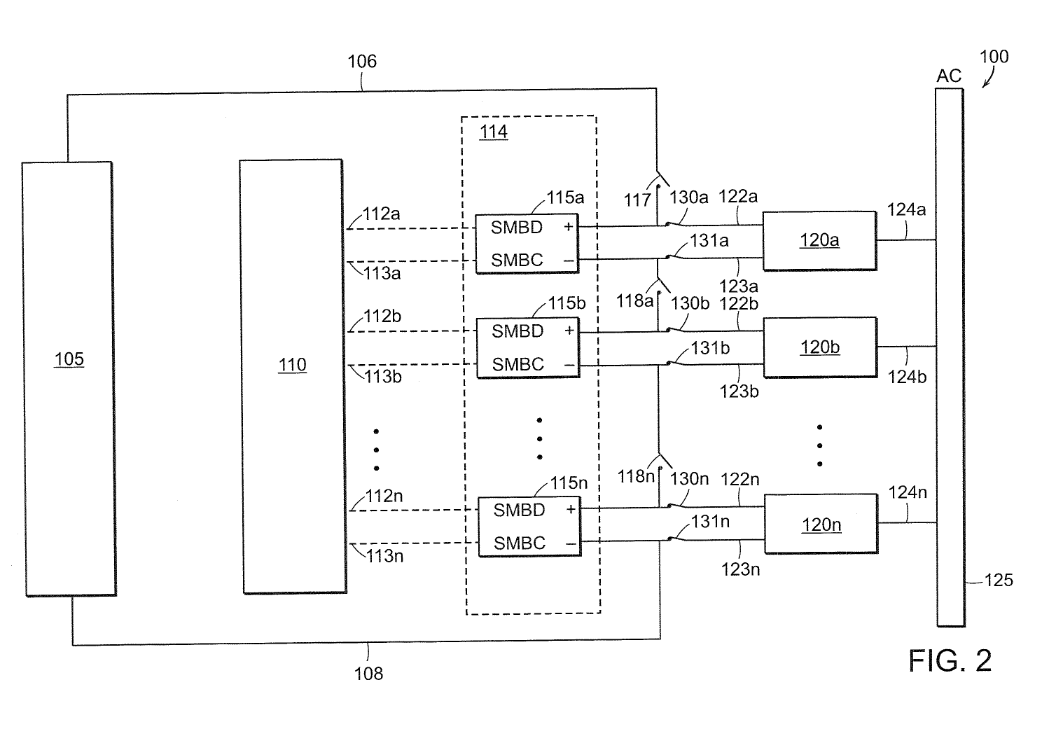

FIG. 2 illustrates electronic circuitry 100, as illustrated in FIG. 1, configured to charge battery modules 115 using a current source. The electronic circuitry 100 operates in accordance with the description of FIG. 1 with the addition that, to charge the battery modules 115, the drive 105 may be disconnected (e.g., switch 117 is in an open position) from the battery modules 115a-n and each battery module 115a-n may be coupled to a respective AC adapter 125a-n via connections to the positive terminals 122a-n and connections to the negative terminals 123a-n of each battery module 115a-n. The AC adapters 120a-n may include charging circuitry, such as a transformer to convert the voltage from an AC outlet, and, if so, the AC charging bus 125 may be a power line. Once the AC adapters 120a-n are connected to an AC power supply (not shown) via the AC charging bus 125, the storage cells of the battery modules 115a-n may be charged from the AC source. The AC adapters 120a-n may provide low-voltage charging for each of the battery modules 115. The AC adapters 120a-n are commonly used in PCs. For example, though powered by a 110V AC line, the adapters may down convert to provide a reduced DC voltage to each module.

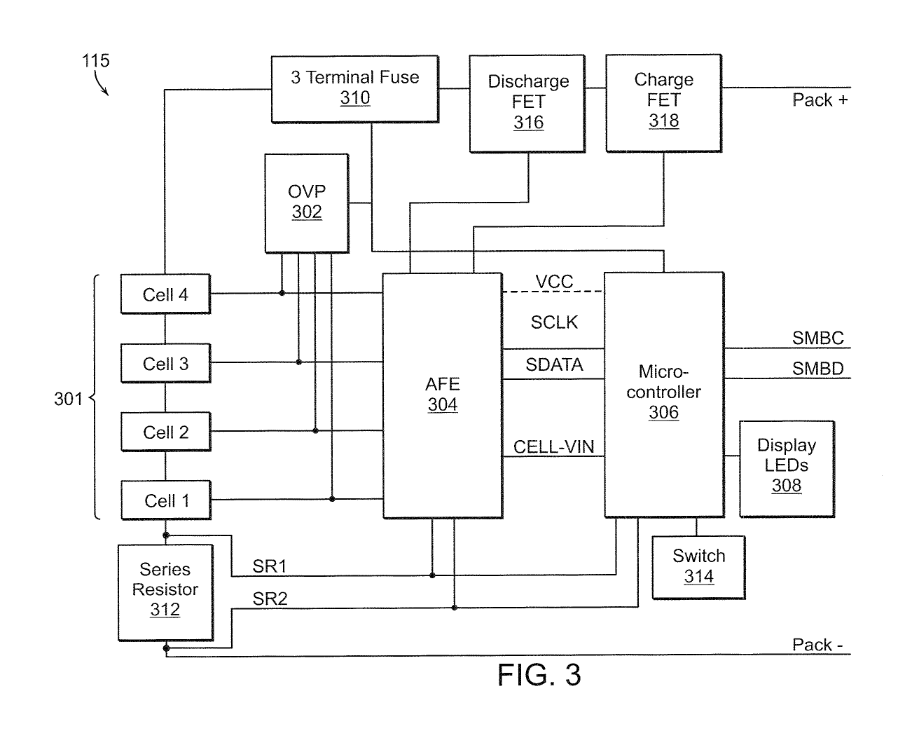

FIG. 3 illustrates an example schematic drawing of the electronic circuitry in each battery module 115 as used in current practice in a PC battery pack upon which the present embodiment may be implemented. In FIG. 3, multiple storage cells 301 may be connected to module management electronics of the battery module 115 including an independent overvoltage protection (OVP) integrated circuit 302, an Analog Front End protection integrated circuit (AFE) 304, and a battery monitor integrated circuit microcontroller 306. One with skill in the art will understand that the present invention is not limited to the aforementioned electronic circuitry of the schematic illustrated in FIG. 3.

The independent overvoltage protection integrated circuit 302 may allow for monitoring of each cell of the battery module 115 by comparing each value to an internal reference voltage. By doing so, the independent overvoltage protection integrated circuit 302 may initiate a protection mechanism if cell voltages perform in an undesired manner, e.g., voltages exceeding optimal levels. The independent overvoltage protection integrated circuit 302 is designed to trigger a non-resetting fuse (not pictured) if a selected preset overvoltage value (eg., 4.35V, 4.40V, 4.45V, or 4.65V) is exceeded for a preset period of time.

The independent overvoltage protection integrated circuit 302 may monitor each individual cell of the multiple storage cells 301 across the VC1, VC2, VC3, VC4, and VC5 terminals (which are ordered from the most positive cell to most negative cell, respectively). Additionally, the independent overvoltage protection integrated circuit 302 may allow the controller 110 to measure each cell of the multiple storage cells 301. The independent overvoltage protection integrated circuit 302 internal control circuit is powered by and monitors a regulated voltage (Vcc).

The independent overvoltage protection integrated circuit 302 may also be configured to permit cell control for any individual cell of the multiple storage cells 301. For example, the charging voltage applied to a module may be applied across the series of cells to charge the three or four cells simultaneously. As one cell reaches a desired level, it may be removed from the series circuit to prevent further charging of that cell as the remaining cells are further charged to the desired level. As a result, all cells in the full array may be charged simultaneously, with cells switched out selectively by the module management electronics as desired charge states are reached.

The controller 110 may use the AFE 304 to monitor battery module 115 conditions and to provide updates of the battery status of the system. The AFE 304 communicates with the battery monitor integrated circuit microcontroller 306 to enhance efficiency and safeness. The AFE 304 may provide power to the battery monitor integrated circuit microcontroller 306 using input from a power source (e.g., the multiple storage cells 301), which would eliminate the need for peripheral regulation circuitry. Both the AFE 404 and the battery monitor integrated circuit microcontroller 306 may have SR1 and SR2 terminals, which may be connected to a resistor 312 to allow for monitoring of battery charge and discharge current. Using the CELL terminal, the AFE 304 may output a voltage value for an individual cell of the multiple storage cells 301 to the VIN terminal of the battery monitor integrated circuit microcontroller 306. The battery monitor integrated circuit microcontroller 306 communicates with the AFE 304 via the SCLK (clock) and SDATA (data) terminals.

The battery monitor integrated circuit microcontroller 306 may be used to monitor the charge and discharge for the multiple storage cells 301. The battery monitor integrated circuit microcontroller 306 may monitor the charge and discharge activity using a resistor 312 placed between the negative cell of the multiple storage cells 301 via the SR1 terminal and the negative terminal of the battery module 115 via the SR2 terminal. The analog-to-digital converter (ADC) of the battery monitor integrated circuit microcontroller 306 may be used to measure the charge and discharge flow by monitoring the SR1 and SR2 terminals. The ADC output of the battery monitor integrated circuit microcontroller 306 may be used to produce control signals to initiate optimal or appropriate safety precautions for the multiple storage cells 301.

While the ADC output of the battery monitor integrated circuit microcontroller 306 is monitoring the SR1 and SR2 terminals, the battery monitor integrated circuit microcontroller 306 (via its VIN terminal) may be able to monitor each cell of the multiple storage cells 301 using the CELL terminal of the AFE 304. The ADC may use a counter to permit the integration of signals received over time. The integrating converter may allow for continuous sampling to measure and monitor the battery charge and discharge current by comparing each cell of the multiple storage cells 301 to an internal reference voltage. The display terminal (DISP) of the battery monitor integrated circuit microcontroller 106 may be used to run the LED display 308 (represented as LED1, LED2, LED3, LED4, and LED 5) of the battery 301. The display may be initiated by closing a switch 314.

The communications protocol of the battery module 115 is the smart battery bus protocol (SMBus), which uses the battery monitor integrated circuit microcontroller 306 to monitor performance and information (e.g., type, discharge rate, temperature, and the like) regarding the performance of the battery module 115 and the information is communicated across the serial communication bus (SMBus). The SMBus communication terminals (SMBC and SMBD) allow the controller 110 to communicate with the battery monitor integrated circuit microcontroller 306. The controller 110 may initiate communication with the battery monitor integrated circuit microcontroller 306 using the SMBC and SMBD pins, and allows the system to efficiently monitor and manage the storage cells 301.

The AFE 304 and battery monitor integrated circuit microcontroller 306 provide the primary and secondary means of safety protection in addition to charge and discharge control of the storage cells 301. Examples of current practice primary safety measures include battery cell and battery voltage protection, charge and discharge overcurrent protection, short circuit protection, and temperature protection. Examples of currently used secondary safety measures include monitoring voltage, battery cell(s), current, and temperature. The OVP integrated circuit 302 may provide a third means of safety protection.

The continuous sampling of the multiple storage cells 301 may allow the electronic circuitry to monitor or calculate characteristics of the battery module 115, such as SOH, SOC, temperature, charge, or the like. One of the parameters that is controlled by the electronic circuitry is the allowed charging current (ACC).

It is preferred, though not required, that the storage cells 301 be in series due to different impedances of cells 301 in the battery module 115. Impedance imbalance may result from temperature gradients within the battery module 115 and manufacturing variability from cell to cell. Two cells having different impedances may have approximately the same capacity when charged slowly. It may be seen that the cell having the higher impedance reaches its upper voltage limit (Vₘₐₓ) in a measurement set (e.g., 4.2V) earlier than the other cell. If these two cells were in parallel in a battery module 115, the charging current would therefore be limited to one cell's performance, which prematurely interrupts the charging for the other cell in parallel. This degrades both battery module capacity as well as battery module charging rate. Such preferred configurations are described in PCT/US2005/047383 which is hereby incorporated by reference in its entirety. A preferred battery is disclosed in U.S. Application Publication No. 2007/0298314 A1 for Lithium Battery With External Positive Thermal Coefficient Layer, filed Jun. 23, 2006, by Phillip Partin and Yanning Song, incorporated by reference in its entirety. Further the teachings of the following patents, published applications and references cited therein are incorporated herein by reference in their entirety.

PCT/US2005/047383, filed on Dec. 23, 2005
U.S. application Ser. No. 11/474,056, filed on Jun. 23, 2006
U.S. application Ser. No. 11/485,068, filed on Jul. 12, 2006
U.S. application Ser. No. 11/821,102, filed on Jun. 21, 2007
PCT/US2007/014591, filed on Jun. 22, 2007
U.S. application Ser. No. 11/486,970, filed on Jul. 14, 2006
PCT/US2006/027245, filed on Jul. 14, 2006
U.S. application Ser. No. 11/823,479, filed on Jun. 27, 2007
PCT/US2007/014905, filed on Jun. 27, 2007
U.S. application Ser. No. 11/474,081, filed Jun. 23, 2006
PCT/US2006/024885, filed on Jun. 23, 2006
U.S. application Ser. No. 11/821,585, filed on Jun. 22, 2007
PCT/US2007/014592, filed on Jun. 22, 2007
U.S. application Ser. No. 12/214,535, filed on Jun. 19, 2008
PCT/US2008/007666, filed Jun. 19, 2008
U.S. Provisional Application No. 61/125,327, filed Apr. 24, 2008
U.S. Provisional Application No. 61/125,281, filed Apr. 24, 2008
U.S. Provisional Application No. 61/125,285, filed on Apr. 24, 2008
U.S. Provisional Application No. 61/195,441, filed on Oct. 7, 2008

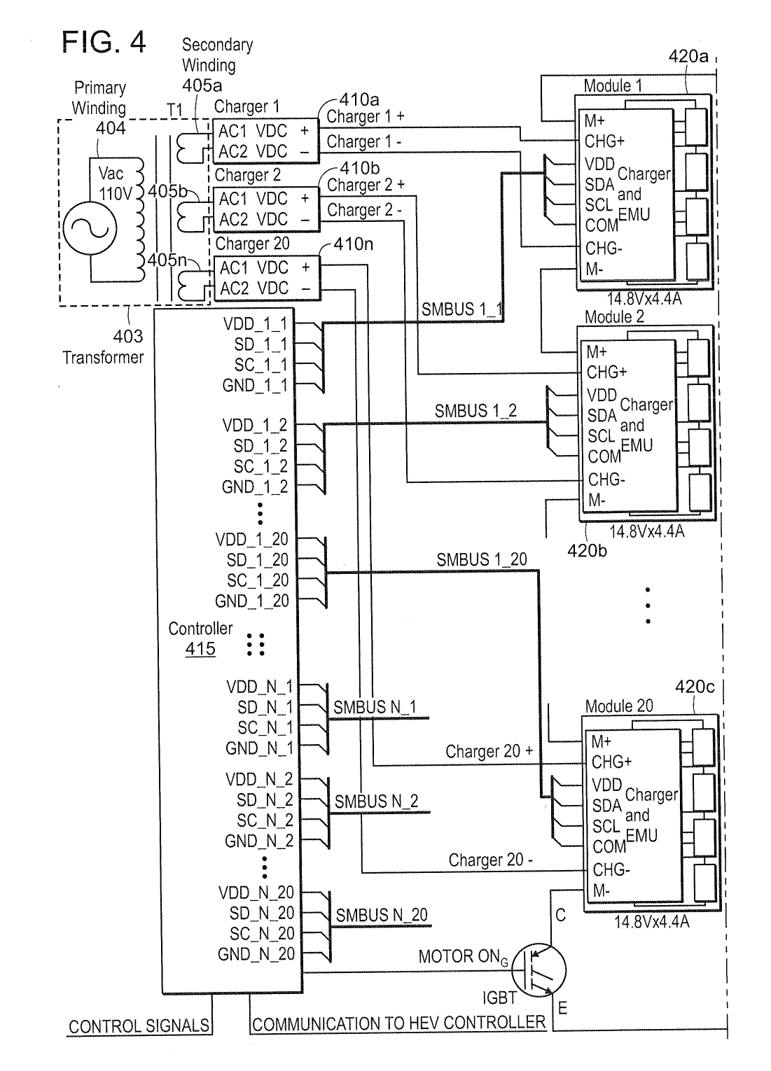

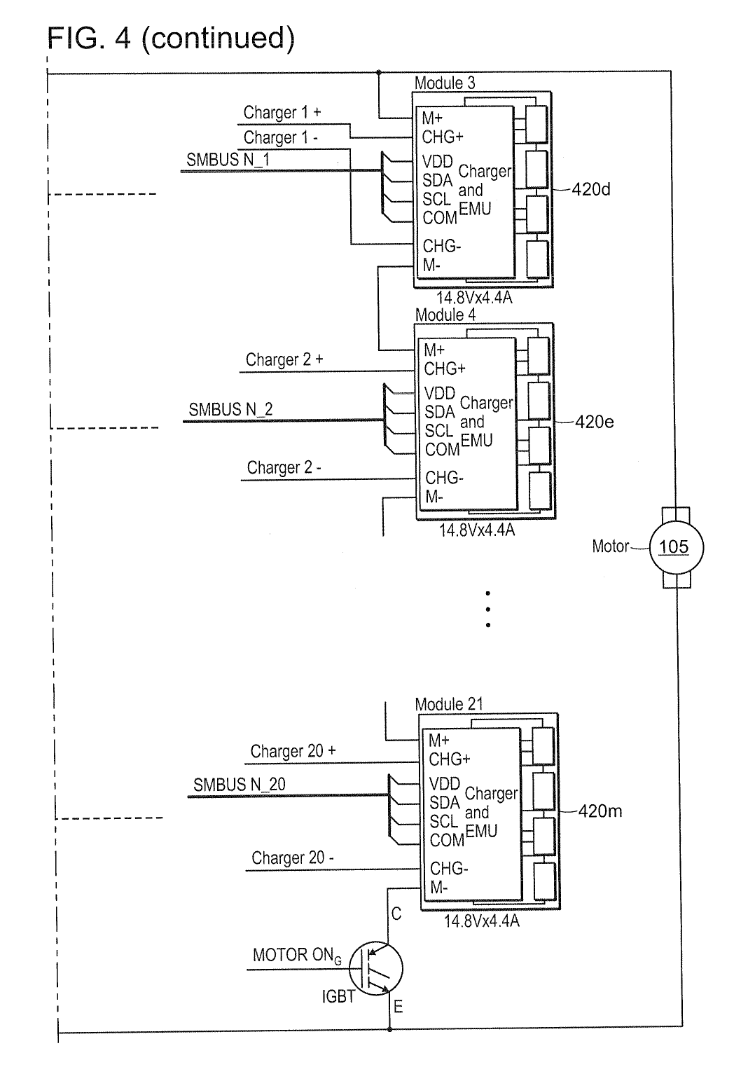

FIG. 4 is a schematic illustration of electronic circuitry 400 that may be used when employing modified battery modules 420a-m. In FIG. 4, the electronic circuitry 400 includes a transformer 403 having a primary winding 404 and secondary windings 405a-n, alternating current-to-direct current (AC/DC) converters 410a-n, a controller 415, a plurality of battery modules 420 a-m, and an electric motor 105. The transformer 403 may transfer electrical energy from an AC source and each AC/DC converter is coupled to a secondary winding; for example, AC/DC converter 410a is coupled to secondary winding 405a. The AC/DC converters 410a-n are also coupled to one or more battery modules 420a-m. Each battery module 420a-m is modified to include its own switches (or relays) to control the charging or discharging of each battery module 420a-m, thus obviating the need for switches 118a-n, 130a-n, 131a-n in FIG. 1. As illustrated in FIG. 4, each battery module 420a-m includes a plurality of storage cells, represented herein as four storage cells that are connected in series. The array of battery modules is multidimensional such that sets of battery modules are connected in series and plural sets of series battery modules are connected in parallel. Each AC/DC converter 410a-n charges one battery module 420a-m of each set, and the controller 415 communicates with each battery module 420a-m independently. The actual number of modules contained in each array is based on the power requirement of a particular motor vehicle. While FIG. 4 depicts each battery module including four storage cells, the four storage cell configuration was provided for illustration purposes only. Each battery module may include multiple storage cells that may be arranged in series, and/or parallel strings.

When assembling cells into battery modules (comprised of a plurality of cells and the electronics to control the charging and discharging of those cells, as well as the electronics to communicate certain parameters such as the SOC, voltage, current, temperature to a host processor), it is preferable to select cells that have similar impedance and capacity characteristics. The weakest cell (i.e. the cell with the lowest capacity or highest impedance) in a battery module will determine the total performance of the module, so it is preferable that all cells have similar impedance and capacity characteristics so that the user is able to extract the largest amount of energy from the module and achieve long cycle life. For a cell having about 4400 mAh capacity, the difference in capacity of any one cell in a module from any one other cell should not exceed 30 mAh. This scales with the size of the cell. Similarly, the difference in impedance of any one cell in a module from any one other cell should not exceed a certain limit as well, typically within 1-10 mOhm

Similarly, it is preferable for a battery array that is comprised of several battery modules be comprised of modules that also have similar impedance and capacity characteristics. When charging or discharging a large battery array, the weakest battery module will limit the capacity and performance of the entire array. As such, selecting modules with similar impedance and capacity characteristics is preferable as it minimizes the amount of “waste” energy that the user can not extract from the battery array. The differences in impedance and capacity of any one module in an array from any one other module is dependent on the size of the module. For 3 cells and 4 cells modules of cells having individual capacity of 4400 mAh and total capacities of about 13200 mAh and 17600 mAh, capacity difference between modules should preferably be less than 90 to 120 mAh and impedance match within 10 mOhm. It is desired to have as close capacity and impedance match as possible.

For many applications, a battery array that is comprised of a single string of series modules is preferred. Such arrays frequently have higher terminal voltages and as a result, lower operating current than an array of equivalent energy density constructed by placing modules in parallel. An advantage of a single series array of modules includes that component costs may be lower because of the lower required current ratings. In addition, lower current levels generate less heat dissipation in their switching and control circuits, and as a result require less thermal management of the battery array.

The main controller (or host controller) of the battery array will periodically poll the status of each of the battery modules in the array. Specifically, the controller will determine the SOH of each module by looking at several parameters of the battery modules, including the open circuit voltage, impedance, cycle count, and temperature of the module, as well as by reading several parameters that are determined by the electronics within the battery module, such as the SOH and available capacity (or full charge capacity) as a percentage of the design capacity of the module.

When the SOH of any one battery module drops below a specific threshold (such as 70%), then the host controller will store in memory the address of the battery module that crossed the threshold, store the SOH of the next weakest battery module, and alert the user that the battery array is in need of servicing. That alert could be in the form of turning on an LED on the exterior of the module, turning on a warning light on the dashboard of a car, or sending out a radio signal to inform the user that the array needs to be serviced. Depending on the SOH values, the host controller can also disable the user from either charging and/or discharging the module.

Also, when the SOH of any one battery module drops below a specific threshold relative to the SOH of any other battery module in the array, the host controller will alert the user that the battery array is in need of servicing (in a similar method to those mentioned above). For example, if the maximum difference threshold is set to 8% and a first module is at 95% SOH and a second module is at 88% SOH, this would cause the host controller to indicate to the user that the array is in need of servicing.

When the battery array is being serviced, a service technician would be able to read the contents of the host controller's memory to determine which battery module needs to be replaced as well as the SOH of the next weakest module. The technician would then select a replacement module with SOH greater than or equal to the SOH of the next weakest module, so as to insure maximum extraction of useful energy from the array during its lifetime.

In the event of a permanent failure of the module, the module would store certain parameters so that the failure mode can be analyzed. These parameters would include each individual cell voltage, the current in or out of the module, and the temperature of the thermistor inside the module at the time of failure, as well as the reason for the permanent failure (cell overvoltage, cell undervoltage, module overvoltage, module undervoltage, overcurrent during charging, overcurrent during discharging, overtemperature, cell imbalance, communication failure, etc.). In the case of the Texas Instruments bq20z90 chip, the host controller would read the PF Flags 1 register which records the source of the permanent failure.

The host controller will read several parameters from the battery modules to determine the SOH of each battery module. Some of these parameters include cell level parameters, such as the individual cell voltages, Qₘₐₓ charge values, and impedance values. Other parameters that the host controller will read are module level parameters, such as the voltage, temperature, current, relative SOC, absolute SOC, full charge capacity, cycle count, design capacity (in mAh or mWh), date of manufacture, SOH (if the module electronics calculate a value for this), safety status, permanent failure status, design capacity design energy, and Qmax charge for the pack. The host controller may also be able to read in certain minimum and maximum values over the life of the module such as module voltage, cell voltage, temperature, charging and discharging current, and charging and discharging power.

When available from the module control electronics, the host controller could simply read the SOH register from each module to get an estimation of the SOH of each module. When this is not available, the host controller could estimate the SOH of the module in various ways. One way would be to compare the current full charge capacity versus the design capacity or design energy to get a measure of the degradation of the module. Another option is to look at the module voltage versus the SOC and compare that to a look-up table of known voltage versus. SOC for various SOH states. Another option is to look at the impedance of each cell and compare that to a look-up table of impedance versus SOH. Another possibility is to compare the Qₘₐₓ of the module with the design capacity. Cycle count could be used to de-rate the SOH as well (i.e., once the cycle count for a given module reaches a certain threshold, the host controller may automatically begin to de-rate the SOFT of that module).

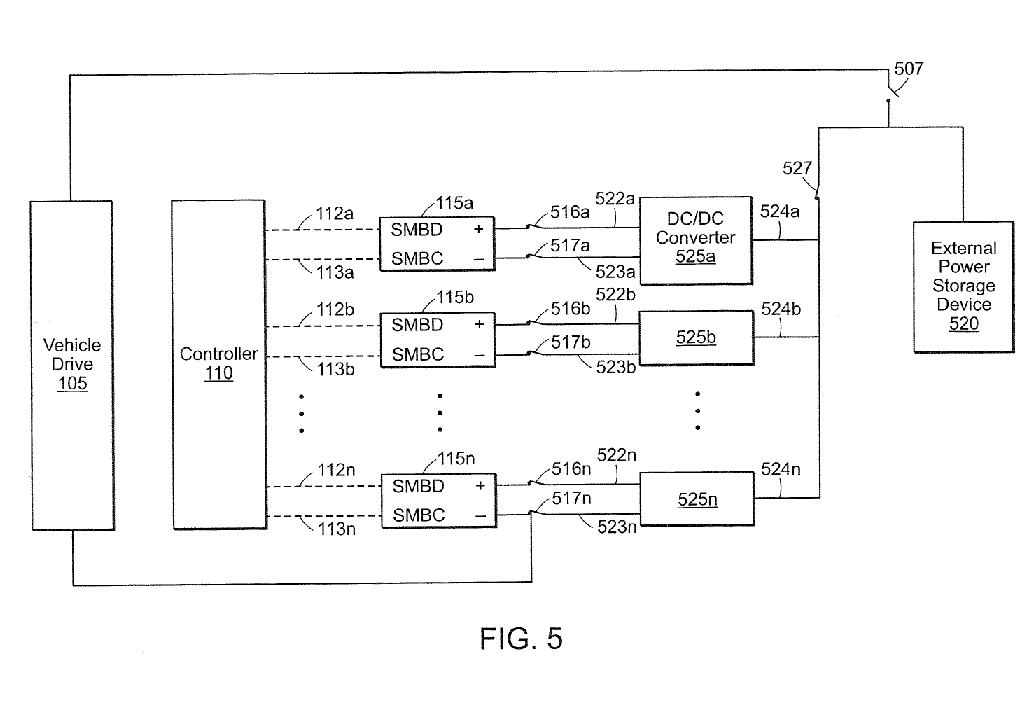

FIG. 5 is an illustration of electronic circuitry 500 of an embodiment that supplements the charging of the battery modules 115a-n, as illustrated in FIG. 2, with regenerative braking. When the drive 105 is in operation, the switch 507 between the drive 105 and an external power storage device 520 is open, and the battery modules 115a-n are used to power the drive 105 of the electric vehicle 505 through the connection illustrated in FIG. 1, not shown in this figure.

As the drive 105 is disengaged from the battery modules 115a-n during braking, the switch 507 is closed and the drive 105 performs as a generator to charge the external power storage device 520, which converts the braking energy to store charge for later use by the battery modules 115a-n. The external power storage device 520 may be designed for high-power charging, which means that the storage device 520 may be charged in seconds. The external power storage device 520 may, for example, be a lead acid battery, nickel-metal hydride battery, lithium-ion battery, or capacitor (such as a supercapacitor). This storage device 520 may be used to partially recharge the individual battery modules 115a-n before external AC power sources are used to charge the battery modules 115a-n as described with respect to FIG. 2. The external power storage device 520 may charge the battery modules 115a-n once the switch 507 between the storage device 520 and the drive 105 is open and the switch 527 between the external power storage device 520 and the battery modules 115a-n is closed. Once the connection between the external power storage device 520 and the battery modules 115a-n is made, the external power storage device 520 may discharge the stored energy via the DC/DC converters 525a-n, respectively, to charge the battery modules 115a-n. In a preferred embodiment, the external power storage device 520 may be maintained in a discharge state of approximately 10% to allow for ready conversion of energy during braking. Additionally, charging from an AC power supply may occur during or after the discharging of the external power storage device 520.

As an alternative to or in addition to the charging approach of FIG. 5, the storage device 520 may be charged by an engine driven generator. As yet another alternative the regenerative or engine driven charging may be across the entire series connection of modules.

To measure and predict performance based battery temperature, voltage, load profile, and charge rate, a controller (e.g., controller 110 of FIG. 1) may be programmed with a variety of algorithms. Below is a pseudo-code description of a main controller algorithm for low-voltage charging and sequencing. Sequentially for each module the controller examines the open circuit voltage and then computes a time required to complete charging of that module by multiplying by a stored constant value. Each module to be charged and the time period for which it needs to be charged are added to a list. The list of modules to be charged is sorted in descending order of time to be charged. Modules are then selectively charged in parallel for corresponding amount of time.

```
disconnect pack from load;
for each module
  read V_oc;
  if V_oc < V_needcharge then
    compute charge_time = V_oc * constant;
    add module:charge_time to modules_to_charge_list;
    ;
sort modules_to_charge_list by charge_time;
for each module on charge_list
  charge for charge_time;
connect to pack to load;
```

Below is a pseudo-code description of a main controller algorithm for a maintenance check and service requesting. At a predefined service check time interval, each module is examined as to its SOH. If the SOH is below a level requiring service then the module is added to a list of modules needing service. Once all modules have been examined, if the list of modules is not empty, then the user is notified and the SOH of the modules requiring service are reported to the user.

```
for each service check time period
  clear service_list;
  for each module
    if SOH < SOH_need_service then
      add module to service_list;
    ;
  if not empty service_list then
    reports service_list and SOH_memory to user
;
```

Below is a pseudo-code description of a main controller algorithm for impedance tracking of the modules in the battery array. The impedance tracking algorithm first measures impedance of each cell in each module, recording a module and cell identifier, time stamp of measurement and the impedance value. Next all cells are scanned over a time period and impedance statistics (such as mean, median, mode, variance, standard deviation) are computed. If the statistics are determined to be abnormal then the abnormal module and cell are reported to the user for service.

```
disconnect pack from load;
for each measurement _time_period
  for each module
    for each cell
      measure impedance;
      store module:cell, timestamp, impedance;
    ;
  ;
;
for each scan_time_period
  for each module
    for each cell
      compute impedance statistics;
      if statistics are abnormal
    ; report module:cell to user;
      else connect pack to load;
  ;
;
```

While this invention has been particularly shown and described with references to example embodiments thereof, it will be understood by those skilled in the art that various changes in form and details may be made therein without departing from the scope of the invention encompassed by the appended claims. For example, while many of the illustrations relate to motor vehicles, an example embodiment may be employed generally in any application requiring an array of energy storage cells, including applications for supplemental power supply and/or storage.

What is claimed is:

1. An electric vehicle comprising:
an electric drive;
a series array of battery modules powering the electric drive, each battery module comprising:
plural electrical energy storage cells; and
module management electronics that monitor each battery module, control each battery module in protective modes and communicate conditions of each battery module;
a controller that receives module conditions communicated from the module management electronics and controls operation of individual battery modules in the array; and
charging circuitry that charges the storage cells of the battery modules from a current source.

2. The electric vehicle as claimed in claim 1, wherein each battery module has a nominal output voltage in the range of about 5V to about 17V.

3. The electric vehicle as claimed in claim 1, wherein each battery module is adapted for ready individual removal and replacement.

4. The electric vehicle as claimed in claim 1, wherein the module management electronics are configured to monitor at least one of the following for each storage cell: temperature, current, capacity, and voltage.

5. The electric vehicle as claimed in claim 1, wherein the controller is configured to monitor at least one of the following for each battery module: temperature, current, capacity, and voltage.

6. The electric vehicle as claimed in claim 1, wherein the module management electronics control the battery module in a temporary shutdown protective mode.

7. The electric vehicle as claimed in claim 1, wherein the module management electronics control the battery module in a permanent shutdown protective mode.

8. The electric vehicle as claimed in claim 1, wherein the module management electronics communicate at least one of the following conditions of each battery module: overcharge, overdischarge, and temperature.

9. The electric vehicle as claimed in claim 1, wherein the charging circuitry is further configured to control the voltage of each battery module to allow for balancing while each battery module is charging.

10. The electric vehicle as claimed in claim 1, further comprising an external power storage device that is coupled to store energy converted during braking and to charge the array by discharging the stored energy.

11. The electric vehicle as claimed in claim 1, further comprising an electric drive controller.

12. The electric vehicle as claimed in claim 11, wherein the battery modules in each array are connected only in series.

13. A method of storing charge for an electric vehicle comprising:
powering an electric drive using a series array of battery modules, each battery module including storage cells and module management electronics;
configuring the module management electronics to monitor each battery module, control each battery module in protective modes, and communicate conditions of each battery module;
receiving module conditions communicated from the module management electronics;
controlling operation of individual battery modules in the array; and
charging the storage cells of the battery modules from a current source.

14. The method as claimed in claim 13, further comprising configuring the battery module to have nominal voltage ranging from about 5V to about 17V.

15. The method as claimed in claim 13, further comprising removing the battery module and replacing the removed battery module with a new battery module.

16. The method as claimed in claim 15, further comprising approximating the State of Charge and State of Health of the removed battery module and selecting the new battery module having comparable State of Charge and State of Health as the removed battery module.

17. The method as claimed in claim 13, further comprising monitoring at least one of the following for each storage cell: temperature, current, capacity, and voltage.

18. The method as claimed in claim 13, further comprising monitoring at least one of the following for each battery module: temperature, current, capacity, and voltage.

19. The method as claimed in claim 13, further comprising controlling the battery module in a temporary shutdown protective mode.

20. The method as claimed in claim 13, further comprising controlling the battery module in a permanent shutdown protective mode.

21. The method as claimed in claim 13, further comprising communicating at least one of the following conditions of the battery module: overcharge, overdischarge, and temperature.

22. The method as claimed in claim 13, further comprising controlling the voltage of each battery module to allow for balancing while each battery module is charging.

23. The method as claimed in claim 13, further comprising coupling an external power storage device to an electric brake, storing energy converted during braking, and charging the array by discharging the stored energy.

24. The method as claimed in claim 13, further comprising controlling the electric drive using an electric drive controller.

25. A battery array comprising:
an array of battery modules, each battery module comprising:
plural electrical energy storage cells; and
module management electronics that monitor each battery module, control each battery module in protective modes, and communicate conditions of each battery module;
a controller that receives module conditions communicated from the module management electronics and controls operation of individual battery modules in the array; and
charging circuitry that charges the storage cells of each battery module from an alternating current source through an individual alternating current to direct current charging circuit to the battery module.

26. The battery array as claimed in claim 25, wherein the battery module has a nominal output voltage in the range of about 5V to about 17V.

27. The battery array as claimed in claim 25, wherein the battery module is adapted for ready individual removal and replacement.

28. The battery array as claimed in claim 25, wherein the battery module has three storage cells.

29. The battery module as claimed in claim 25, wherein the battery module has four storage cells.

30. An electric vehicle comprising:
an electric drive;
an array of battery modules powering the electric drive, each module having a nominal output voltage in the range of about 9V to about 17V and being adapted for ready individual removal and replacement, comprising:
plural electrical energy storage cells; and
module management electronics that monitor temperature, current, capacity, and voltage of each battery module, control each battery module in temporary shutdown protective mode and permanent shutdown protective mode, and communicate temperature, current, capacity, and voltage conditions of each battery module;
a controller that receives battery module overcharge, overdischarge, and temperature conditions communicated from the module management electronics, controls operation of individual battery modules in the array, controls individual connections between the drive, the battery modules, and the charging circuitry, and alerts for replacement of battery modules; and
charging circuitry that charges the storage cells of the battery modules from an alternating current source through an individual alternating current to direct current charging circuit to the battery module.

31. The electric vehicle as claimed in claim 30, wherein the charging circuitry is configured to control the voltage of each battery module to allow for balancing while each battery module is charging.

32. The electric vehicle as claimed in claim 30, further comprising an electric drive controller.

33. A battery array comprising:
an array of battery modules, each module having a nominal output voltage in the range of about 5V to about 17V and being adapted for ready individual removal and replacement, comprising:
plural electrical energy storage cells; and
module management electronics that monitor temperature, current, capacity, and voltage of each battery module, control the battery module in temporary shutdown protective mode and permanent shutdown protective mode and communicate temperature, current, capacity, and voltage conditions of each battery module;
a controller that receives battery module overcharge, overdischarge, and temperature conditions communicated from the module management electronics and controls operation of individual battery modules in the array; and
charging circuitry that charges the storage cells of each battery module from an alternating current source through an individual alternating current to direct current charging circuit to the battery module and configured to control the voltage of each battery module to allow for balancing while each battery module is charging.

34. A method of charging a battery array comprising:
providing an alternating current supply voltage;
in parallel alternating current to direct current charging circuits, down-converting the alternating current supply voltage to individual direct current charging voltages;
applying the direct current charging voltages to respective individual battery modules to charge one or more cells in each battery module.

35. The method as claimed in claim 34 wherein each battery module charges multiple cells in the module under control of module management electronics in the battery module.

36. The method as claimed in claim 34 wherein all battery modules are charged simultaneously in parallel.

37. The method as claimed in claim 34 wherein the direct current charging voltage applied to each module is applied across a series of cells in the module.

38. The method as claimed in claim 34 wherein all cells are charged simultaneously from the individual direct current charging voltages.

39. A battery array comprising:
alternating current supply voltage terminals;
direct current output voltage terminals;
at least one array of battery modules extending between the output voltage terminals; and
a plurality of alternating current to direct current charging circuits, each down-converting an alternating current supply voltage at the alternating current supply voltage terminals to an individual direct current charging voltage applied to an individual module of the array.

40. The battery array as claimed in claim 39, wherein the batter modules in each array are connected only in series.
